(19) United States
(12) Patent Application Publication
(10) Pub. No.: US 2025/0220616 A1
(43) Pub. Date: Jul. 3, 2025

(54) LOCALLY REJECTED AND LOCALLY ALLOWED NETWORK SLICE MESSAGING AND DEVICE CONFIGURATION

(71) Applicant: Lenovo (Singapore) Pte. Limited, Singapore (SG)

(72) Inventor: GENADI VELEV, DARMSTADT (DE)

(21) Appl. No.: 18/850,541

(22) PCT Filed: Mar. 27, 2023
(86) PCT No.: PCT/IB2023/053026

§ 371 Date: Sep. 24, 2024

Related U.S. Application Data
(60) Provisional application No. 63/324,070, filed on Mar. 26, 2022.

(51) Int. Cl. H04W 60/04; H04W 48/18; H04W 64/00

(52) U.S. Cl. CPC H04W 60/04; H04W 48/18; H04W 64/006

(57) ABSTRACT

A method includes sending, by a user equipment (UE), a registration request message to a mobile communication network, the message including a core network capability indication that the UE supports partial registration of at least one network slice that is not available within all of the tracking areas in a registration area. The method includes, receiving, from the mobile communication network, a mobility management message having parameters for (i) one or more allowed network slices supported by each tracking area of the registration area, and (ii) a partial network slice registration identifying at least one local network slice that is supported in at least one, but not supported within all of the tracking areas. The method includes configuring the UE to use the local network slice of the partial network slice registration when the UE is located in the tracking area supporting the local network slice.

### RELATED APPLICATION

This application claims priority to U.S. Provisional Application No. 63/324,070 filed Mar. 26, 2022, the content of which is fully incorporated herein by reference.

### TECHNICAL FIELD

The present disclosure relates to wireless communications, and more specifically to communication devices that register with a mobile network core for network slices.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

In 5G networks, network slicing allows a network operator to divide the communication network into finer, small networks optimized for certain features. A UE may be configured with network slice relevant information, such as a network slice selection policy (“NSSP”), used to select a particular network slice. The UE may request registrations to multiple network slices by a mobile network core that manages a registration area. The registration area may have multiple tracking areas that may differ in which network slices are available. The mobile network core only registers the UE for network slices that are available across the entire registration area.

### SUMMARY

The present disclosure relates to methods, apparatuses, and systems that support wireless communication by a device. A communication device is configured to support partial network slice registration, whereby the device is able to track and access network slices that are not available within all of the different tracking areas within a registration area. The core network is also configured to respond to a registration request by a device that has this capability with additional information that allows the device to know which network slices are rejected, a reason for the rejection of the network slice, and in which tracking areas within the registration area the rejected network slice is available/unavailable. By enabling/supporting partial network slice registration, the network is able to indicate to the device that a (partially) rejected network slice may be available in another tracking area of the assigned registration area. This allows the device to initiate a registration with and use a partially rejected network slice that was rejected in a first tracking area of the assigned registration area but may be available in another tracking area. A larger registration area can thus be provided to the device.

Some implementations of the method and apparatuses described herein may further include the device sending a registration request message to a mobile communication network while the device is in a first tracking area. The registration request message includes a core network capability indication that the device supports a partial registration of at least one network slice that is not available within all of the tracking areas in a registration area. The implementation further includes receiving, from the mobile communication network, a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area. The device is configured to use the local network slice of the partial network slice registration when the device is located in the tracking area supporting the local network slice.

In some implementations of the method and apparatuses described herein, the received mobility management message is one of a registration accept message or a device configuration update command. The at least one local network slice is a partially allowed or partially rejected network slice. The partial network slice registration is provided within the mobility management message as one of (i) a single parameter together with the at least one allowed slice; or (ii) a separate parameter from the at least one allowed slice.

In some implementations of the method and apparatuses described herein, the capability indication indicates that the device supports partial rejection of network slices. The partial network slice registration includes a partially rejected network slice that is unavailable in the first tracking area and an associated list of tracking areas in which the partially rejected network slice is one of available or unavailable. Some implementations of the method and apparatuses described herein may further include, in response to one of (i) detecting device movement to a tracking area in which the partially rejected network slice becomes available and (ii) an application requesting a connectivity to the partially rejected network slice, sending to the mobile communication network a registration request for the partially rejected network slice.

Aspects of the present disclosure further relate to methods, apparatuses, and systems that support wireless communication by a network device. Some implementations of the method and apparatuses described herein may further include the network device receiving, from a second device, a registration request message that includes a core network capability indication that the second device supports partial registration with network slices. In response to receipt of the core network capability indication, the network device identifies a registration area including more than one tracking area and which network slices are not supported within all of the more than one tracking area within the registration area. The network device transmits, to the second device, a mobility management message comprising parameters for the registration area, a partial network slice registration identifying at least one local network slice that is not available in all tracking areas within the registration area, and an associated list of tracking areas in which the local network slice is one of allowed or rejected.

Some implementations of the method and apparatuses described herein may further include generating the mobility management message by incorporating, within the mobility management message, the partial network slice registration, which comprises: (i) at least one of a partially rejected network slice and a partially allowed network slice; (ii) a reject cause for each partially rejected network slice; and (iii) a tracking area list of one or more tracking areas in which an identified network slice is partially rejected or partially allowed.

Some implementations of the method and apparatuses described herein may further include identifying at least one additional tracking area that supports a requested slice, the at least one additional tracking area located outside of the registration area. The method includes transmitting, with the mobility management message, parameters of at least one additional tracking area to enable the second device to register with the at least one additional tracking area during a subsequent search for selecting a cell with the requested slice outside the registration area.

### BRIEF DESCRIPTION OF THE DRAWINGS

Various aspects of the present disclosure for enabling partial network slice registration by communication devices are described with reference to the following Figures. The same numbers may be used throughout to reference like features and components shown in the Figures.

FIG. 1 illustrates an example of a wireless communications system that supports partial registration to network slices within tracking areas of a registration area, in accordance with aspects of the present disclosure.

FIG. 2 illustrates an example block diagram of a communication architecture with a network core that supports configuring a UE for partial registration to network slices within a registration area, in accordance with aspects of the present disclosure.

FIG. 3 illustrates an example communication system with a user equipment (UE) in an assigned tracking area with a partially rejected network slices being locally unavailable, but available in other tracking areas within a registration area, in accordance with aspects of the present disclosure.

FIG. 4 depicts an example communication system with a UE in a tracking area with a network slice being locally available, but unavailable in other tracking areas within a registration area, in accordance with aspects of the present disclosure.

FIG. 5 depicts a signaling flow diagram for a registration procedure with partially rejected Network Slice Selection Assistance Information (NSSAI), in accordance with aspects of the present disclosure.

FIG. 6 depicts a signaling flow diagram for a registration procedure with partially accepted NSSAI, in accordance with aspects of the present disclosure.

FIG. 7 illustrates an example of a block diagram of a device that includes a partial network slice registration capability, in accordance with aspects of the present disclosure.

FIG. 8 illustrates an example of a block diagram of a base node that supports configuring of a UE for partial registration to network slices within a resource area in accordance with aspects of the present disclosure.

FIGS. 9 through 10 illustrate flowcharts of methods that support partial network slice registration capability in a UE and base node, in accordance with aspects of the present disclosure.

### DETAILED DESCRIPTION

Disclosed are methods, apparatus, and systems for solving the problem with network slices being restricted from or unavailable to a user equipment (UE) that registers within a registration area (RA) that can include those network slices.

According to the current 5G specifications, the allowed network slices (i.e., identified by allowed NSSAI, Network Slice Selection Assistance Information) is described as all S-NSSAIs (Single NSSAI) of the Allowed NSSAI are available in all TAs of the Registration Area (RA). Thus, all neighboring Tracking Areas that support the allowed NSSAI may be allocated into the same RA that is assigned to the UE. When the AMF creates a Registration Area (RA) with one or more TAs, all the S-NSSAIs of the Allowed NSSAI needs to be available in all the TAs of the RA. If the Requested NSSAI contains an S-NSSAIs that is available only in some specific TA(s), the Access and Mobility Management Function (AMF) of the network node will have trouble creating a reasonably-sized RA that is suitable considering the anticipated paging load vs the load generated due to Mobility Registration Update (MRU) requests. For example, if the UE requests an S-NSSAI that is available in the current TA, but not available in some other TAs, then due to the current restriction, the other TAs cannot be added to the RA. Also, if the UE requests an S-NSSAI that is not available in the current TA, then the network would reject the S-NSSAI for the RA and the UE is not allowed to request the S-NSSAI until the UE moves outside of the RA.

During a UE registration procedure or in response to receiving a UE configuration update message, the 5^{th} Generation Core network (e.g., 5GC and more specifically the AMF) may send to the UE a registration accept message with one or more of the following parameters/elements related to the network slice configuration of the UE: allowed NSSAI (i.e., a list of one or more S-NSSAIs); configured NSSAI; rejected NSSAI; or pending NSSAI. While the rejected NSSAI indicates to the UE that one or more S-NSSAIs of the requested NSSAI are not supported, the network (e.g., AMF) provides the reject cause to the UE, and the UE is prohibited from using the rejected NSSAI. The UE receives no information on how to initiate a registration for a rejected S-NSSAI that was rejected in a first TA of the RA but may be available in another TA of the RA. With this conventional implementation, the UE receives the assignment of either a large RA with restriction on access to the S-NSSAIs of the rejected NSSAI within the whole RA or the UE receives an assignment of a small RA comprised of a single TA if the neighboring TAs do not support one of the network slices of the local TA in which the UE completes the registration.

Accordingly, the present disclosure provides a partial network slice registration capability by which a UE is able to request and receive additional information about the availability of network slices in surrounding tracking areas that also allows the UE to be assigned a larger RA that includes TAs where one or more network slices are unavailable, e.g., the partially rejected network slices. The UE is further aware of in which TAs these rejected network slices are available, enabling the UE to make a request to register for those slices when in the associated TA and correspondingly to use these network slices, i.e., to establish Protocol Data Unit (PDU) Session(s). According to one aspect, the UE sends a registration request message to a mobile communication network while the UE is in a first tracking area. The registration request message includes a core network capability indication that the device supports a partial registration of at least one network slice that is not available within all of the tracking areas in a registration area. The UE receives, from the mobile communication network, a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area. The partial network slice registration includes: (i) at least one of a partially rejected network slice and a partially allowed network slice; (ii) a reject cause for each partially rejected network slice; and (iii) a tracking area list of one or more tracking areas in which an identified network slice is partially rejected or partially allowed. The UE is configured to use the local network slice of the partial network slice registration when the device is located in the tracking area supporting the local network slice. The UE is further able to identify, from the tracking area list, when a rejected network slice is available in another one of the TAs within the assigned RA and request registration to the partially rejected network slice.

According to one additional aspect, in response to receipt of a registration request message that includes a core network capability indication that the UE supports partial registration with network slices, the core network (e.g., the AMF and/or NSSF) identifies a registration area including more than one tracking area and which network slices are not supported within all of the more than one tracking area within the registration area. The network transmits, to the UE, a mobility management message comprising parameters for the registration area, a partial network slice registration identifying at least one local network slice that is not available in all tracking areas within the registration area, and an associated list of tracking areas in which the local network slice is one of allowed or rejected. The network thus enables the UE to operate within a larger RA with the additional information about which TAs in the assigned RA include the partially rejected network slices.

Aspects of the present disclosure relate to enabling more granular acceptance and rejection of network slices within tracking areas of a registration area for communication services. In response to a registration request message by a device to a mobile communication network, the mobile communication network sends a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area. The device is configured to use the local network slice of the partial network slice registration when the device is located in the tracking area supporting the local network slice.

Aspects of the present disclosure are described in the context of a wireless communications system. Aspects of the present disclosure are further illustrated and described with reference to device diagrams, and flowcharts that relate to partial network slice registration for UEs within RAs.

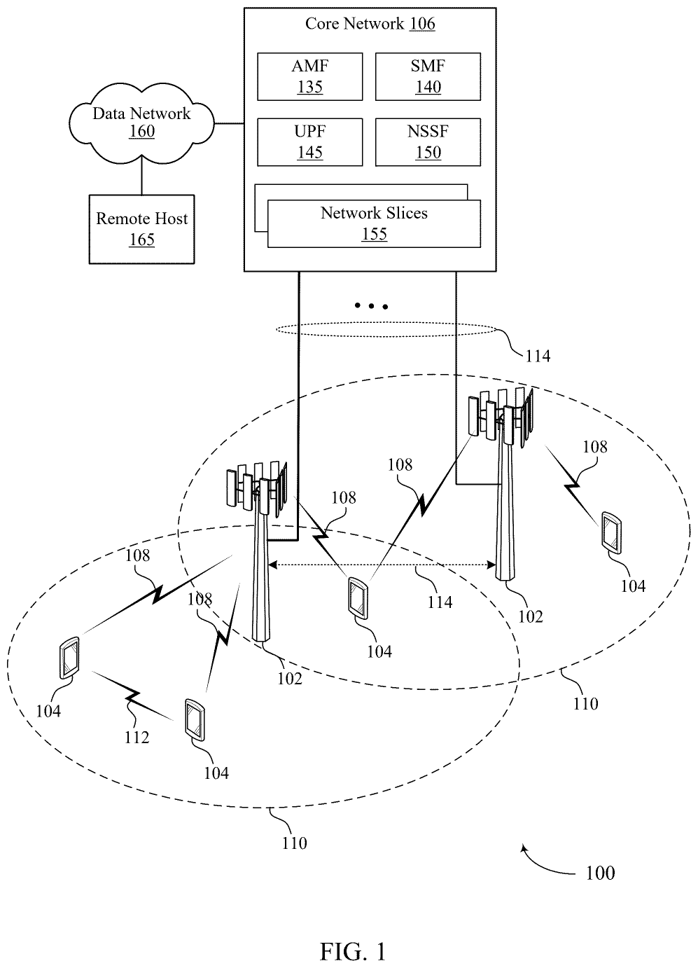

FIG. 1 illustrates an example of a wireless communications system 100 that supports partial registration to network slices within tracking areas of a registration area, in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2,N3, or another network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions to data network 160, such as the Internet and private data network, among other networks. In some embodiments, the UEs 104 communicate with a remote host 165 via a network connection with the core network 106. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

In one embodiment, the mobile core network 106 includes several network functions (“NFs”) and multiple network slices 155. As depicted, the mobile core network 106 includes at least one AMF 135, at least one session management function (“SMF”) 140, at least one UPF 145, and at least one network slice selection function (“NSSF”) 150. Although a specific number of NFs are depicted in FIG. 1, one of skill in the art will recognize that any number of NFs may be included in the mobile core network 106.

The AMF 135 and SMF 140 are examples of control plane network functions of the mobile core network 106. Control plane network functions provide services such as UE registration, UE connection management, UE mobility management, data session management, and the like. The UPF 145 provides user plane (e.g., data) services to the UE 104. For example, a data connection between the UE 104 and a remote host 165 is managed by a UPF 145.

The NSSF 150 selects a proper network slice 155 (and a network slice instance) for a particular UE connection. The NSSF 150 may be a stand-alone NF or co-located with the AMF 135 or another NF (e.g., a NRF, or a PCF). The network slices 155 are logical networks within the mobile core network 106. The network slices 155 are partitions of resources and/or services of the mobile core network 106. Different network slices 155 may be used to meet different service needs (e.g., latency, reliability, and capacity). Examples of different types of network slices 155 include enhanced mobile broadband (“eMBB”), massive machine-type communication (“mMTC”), and ultra-reliability and low latency communications (“URLLC”). A mobile core network 106 may include multiple network slice instances of the same network slice type.

While specific embodiments are illustrated and described herein, the present disclosure is not intended to be limited to the implementation of any particular wireless communication system architecture or protocol.

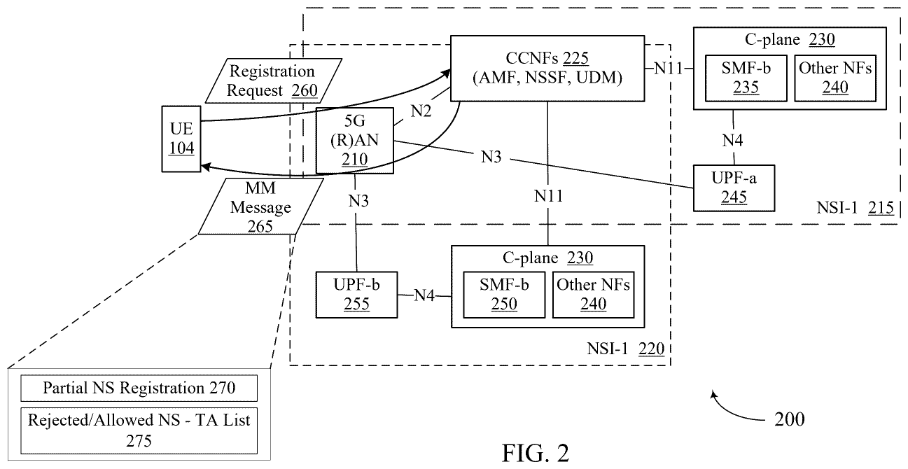

FIG. 2 illustrates an example block diagram of a communication system with a network core that supports providing a UE with partially rejected and partially allowed network slices within a registration area, in accordance with aspects of the present disclosure. Specifically, FIG. 2 depicts a network architecture 200 used for registering UE 104 and assigning UE 104 with an RA that includes TAs with one or more partially rejected and/or partially allowed network slices, according to embodiments of the disclosure. The network architecture 200 may be an embodiment of the wireless communication system 100. As depicted, the network architecture 200 includes a UE 104, a 5G (R)AN 210, a first network slice (here, network slice instance 1 “NSI-1”) 215, a second network slice (here, network slice instance 2 “NSI-2”) 220, and a set of common control plane network functions (“CCNFs”) 225. The set of common control plane network functions 225 may include at least an AMF, a NSSF, and a UDM. Each network slice instance also has dedicated network functions. Here, the first network slice instance 215 includes a control plane 230 with a first SMF 235 (“SMF-a”) and other dedicated network functions 240 and a first UPF 245 (“UPF-a”). Additionally, the second network slice instance 220 includes a control plane 230 with a second SMF 250 (“SMF-b”) and other dedicated network functions 240 and a second UPF 255 (“UPF-b”).

The 5G (R)AN 210 may include one or more base stations 102 (FIG. 1). The first and second network slice instances 215, 220 may be embodiments of the network slices 155. Additionally, the first and second SMFs 235, 250 and the first and second UPFs 245, 255 may be embodiments of the SMF 140 and UPF 145, respectively. The 5G (R)AN 210, the set of common control plane network functions 225, and the network slice instances 215, 220 (and their dedicated network functions) collectively form a mobile communication network with which the UE 104 communicates.

In the network architecture 200, the UE 104 may communicate with the 5G (R)AN 210 using a Uu interface, the 5G (R)AN 210 may communicate with the set of common control plane network functions 225 using an N2 interface and with the first and second UPFs 245, 255 using an N3 interface. The first SMF 235 and the first UPF 245 may communicate using an N4 interface. Likewise, the second SMF 250 and the second UPF 255 may also communicate using an N4 interface. The set of common control plane network functions 225 may communicate with the control planes 230 within the first and second network slice instances 215, 220 using an N11 interface. UE 104 communicates registration request 260 to network slices via RG (R)AN 210 to CCNFs 225. CCNFs 225 transmit partial registration message 265 via 5G (R)AN 210 to UE 104.

As shown, in response to a UE registration procedure or in response to a UE configuration update procedure (depicted by registration request 260), the CCNF's of 5GC (e.g., AMF, NSSF, UDM) may transmit to the UE 104 in the registration accept message or UE configuration update command message, a mobility management message 265 that includes: parameters for the registration area, a partial network slice registration 270 identifying at least one local network slice that is not available in all tracking areas within the registration area, and an associated list 275 of tracking areas in which the local network slice is either allowed or rejected (or alternatively, either available or unavailable). According to one embodiment, the mobility management message 265 includes one or more of the following elements related to the network slice configuration of the UE: allowed Network Slice Selection Assistance Information (NSSAI), configured NSSAI, rejected NSSAI or pending NSSAI. Additionally, according to one aspect, the partial network slice registration further includes an identification of the partially rejected NSSAI or partially allowed NSSAI, along with a list of the TAs in which each of these partially allowed or partially rejected NSSAIs exists.

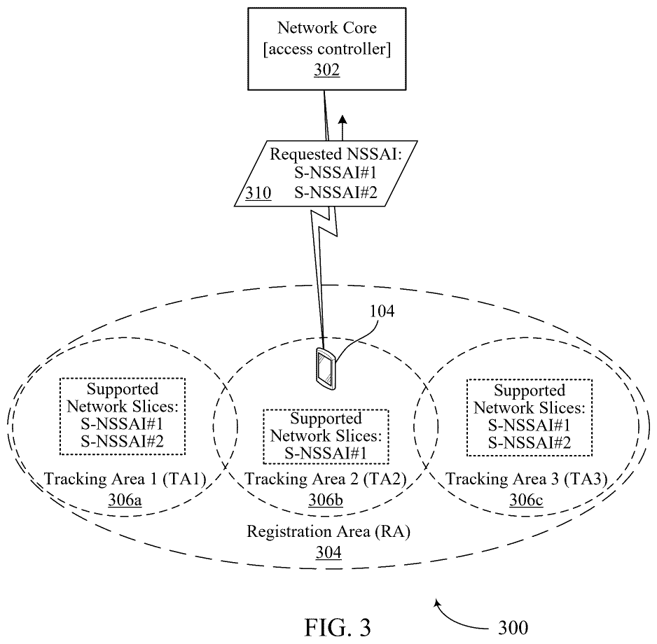

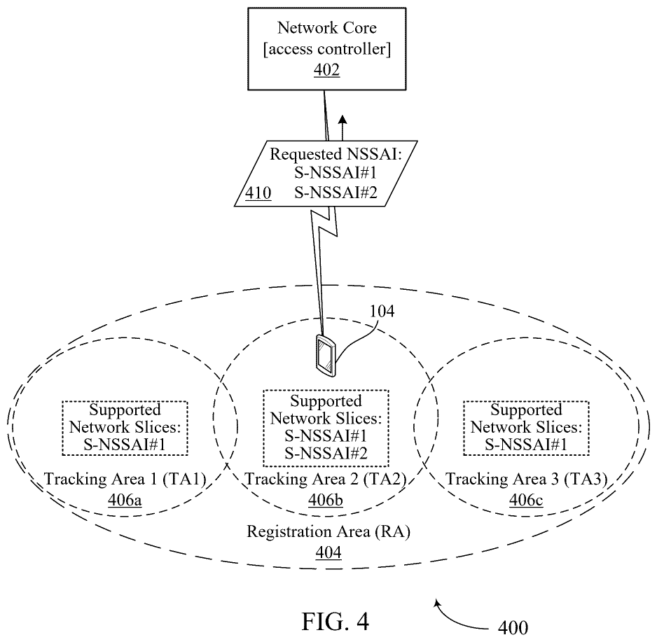

FIGS. 3 and 4 provide specific examples of the application of a partial network slice registration for a UE where mobile core network 106 (FIG. 1) assigns to a requesting UE 104 a RA with three adjacent TAs, TA1, TA2, and TA3, respectively 306a-306c and 406a-406c. FIGS. 3 and 4 are described with continued reference to components from FIGS. 1 and 2. Referring to FIG. 3, there is illustrated an example communication system 300 with a user equipment (UE) 104 in a first local tracking area TA2 306b. As shown, TA2 306b includes a single network slice, S-NSSAI #1 that is locally available to the UE 104. TA1 and TA3 include a second network slice, S-NSSAI #2, which are available within those TAs, but unavailable in TA2. According to one aspect of the disclosure, mobile core network 106 assigns the RA to the UE 104 with these three TAs. FIG. 4 depicts an example communication system 300 with the UE 104 in the assigned tracking area, TA2, which has two network slices that are locally available to the UE 104. One of the network slices, S-NSSAI #1 is, however, unavailable in other tracking areas, TA1 and TA3, within the assigned registration area.

In FIG. 3, communication system 300, includes 5G communication network core (5GC) 302 managing registration area 304 which includes TA1 306a, TA2 306b, and TA3 306c. The TA1 supports S-NSSAI #1 and S-NSSAI #2, the TA2 306b supports S-NSSAI #1 and the TA3 306c supports S-NSSAI #1 and S-NSSAI #2. A UE 104 is located in TA2 306b and sends a requested NSSAI 310 to register with the network for available network slices. During the registration procedure, the 5GC (e.g., AMF and/or NSSF) creates and sends to the UE 104 a mobility management message (or registration accept message) to assign the RA 304 with network slice resources to the UE 104. With the new capability of a partial network slice registration, the mobility management message received by the UE 104 includes: (i) Registration area includes: TA1 306a, TA2 306b and TA3 306c; (ii) Allowed NSSAI includes S-NSSAI #1; and (iii) partially Rejected NSSAI includes S-NSSAI #2, and a cause value for the rejection for the current RA. For simplicity in presenting the description, references herein to 5GC, or more specifically the AMF or NSSF and the functions provided by these components of the core network shall be generally described as the “network” or, in some embodiments, the “access controller”. By providing the partially rejected NSSAI, the access controller (302) provides the UE 104 with location information for other network slices that are not supported within TA2 306b where UE 104 is located. This partially rejected functionality allows the UE 104 to be assigned the RA 304 with all three TAs 306a-306c, and the UE 104 is now also able to track rejected slices and request registration to use S-NSSAI #2 in the TA1 306a or in TA3 306c when UE 104 enters either of these other TAs 306a and 306c. In case that the UE has not indicated to the AMF the capability of support of partial network slice registration, the AMF would not consider the S-NSSAI #2 as partially rejected, which means that the RA may comprise TA1, TA2 and TA3 and the rejected S-NSSAI #2 would be rejected for the whole RA.

In the embodiment presented by FIG. 4, communication system 400, includes 5G communication network core (5GC) 402 managing registration area 404 which includes TA1 406a, TA2 406b, and TA3 406c. TA1 406a supports S-NSSAI #1, TA2 406b supports S-NSSAI #1 and S-NSSAI #2, and TA3 406c supports S-NSSAI #1. The UE 104 is again located in TA2 406b and sends a registration request 410 for NSSAI, including with the request a core network capability indication that the UE 104 supports partial registration with network slices. Based on the identification that TA2 406b, which is a local TA of the UE 104, supports both S-NSSAI #1 and S-NSSAI #2, the access controller (402) creates and sends to the UE 104 a different registration accept message including, which now includes: (i) Registration area includes: TA1, TA2, TA3; (ii) Allowed NSSAI includes S-NSSAI #1; and (iii) partially allowed NSSAI includes S-NSSAI #2.

The access controller (302) considers that the UE 104 is currently located in TA2 406b and the TA2 406b supports S-NSSAI #1 and S-NSSAI #2, whereas the neighbor TA1 406a and TA3 406c support only S-NSSAI #1. Therefore, the AMF/NSSF may assign the RA 404 including all three TAs 406a-406c, but expressly limit the UE 104 to only access S-NSSAI #2 while within TA2 406b. The assigned RA 404 is thus similar to that of FIG. 3, but with the caveat of S-NSSAI #2 only being available within TA2 406b. In case that the UE has not indicated to the AMF the capability of support of partial network slice registration, the AMF would not consider the S-NSSAI #2 as partially allowed, which means that the RA would comprise TA2 and the allowed NSSAI would comprise S-NSSAI #1 and S-NSSAI #2.

According to a first embodiment, when the access controller (402) rejects a network slice (identified by S-NSSAI), which is not supported in the current/local TA from which the device transmits the registration request (requested NSSAI 410), but the local TA is within a subset of the TAs of the RA 404 that is to be assigned to the UE 104, the access controller (402) sends to the UE a partial network slice registration message indicating that (a) the S-NSSAI is rejected locally or on per TA basis (i.e., partially rejected) and (b) in which TAs of the RA the rejected S-NSSAI may be supported. In one additional implementation of this embodiment, the list of TAs that the partially rejected S-NSSAI may be supported in can include other TAs neighboring the RA.

According to a second embodiment, when the access controller (302) partially allows a network slice (S-NSSAI), which is supported in the current/local TA of the UE 104 and in a subset of the TA(s) of the RA, the access controller (402) sends to the UE 104 a partial network slice registration message indicating that the S-NSSAI of the partially allowed NSSAI is not supported in one or more TAs of the RA 404. This information includes a list of the TAs in which the partially allowed NSSAI is allowed (i.e. supported) or a list of the TAs in which the partially allowed NSSAI is not allowed (i.e. not supported).

According to the first embodiment, the partially rejected S-NSSAI (single NSSAI), which is available in some of the TAs of the RA, is associated with the TA where the S-NSSAI is not available. The partially rejected NSSAI, which can also be referred to as a “locally rejected NSSAI” is sent to the UE to indicate that the S-NSSAI(s) included in this indication are partially rejected in the RA and/or partially available in the RA. Each of the partially rejected S-NSSAIs is associated with a list of TAs where the partially rejected S-NSSAI is not supported.

According to one aspect, the access controller sends the partially rejected NSSAI to the UE, and each S-NSSAI of the rejected NSSAI is associated with a reject cause. This reject cause indicates that the S-NSSAI is partially rejected in the RA (e.g., rejected partially for the current TA). Thus, in response to receiving the core network capability indication for partial registration of network slices from the UR, the access controller creates and sends to the UE a registration accept message that indicates: (i) the registration area includes: TA1, TA2 and TA3; (ii) allowed NSSAI includes S-NSSAI #1; and (iii) rejected NSSAI includes S-NSSAI #2, with cause value =rejected partially for the current RA, and an associated list of rejected TAs. The latter set of information indicates to the UE that the S-NSSAI #2 is not supported in some of the TAs of the current RA, namely in TA2.

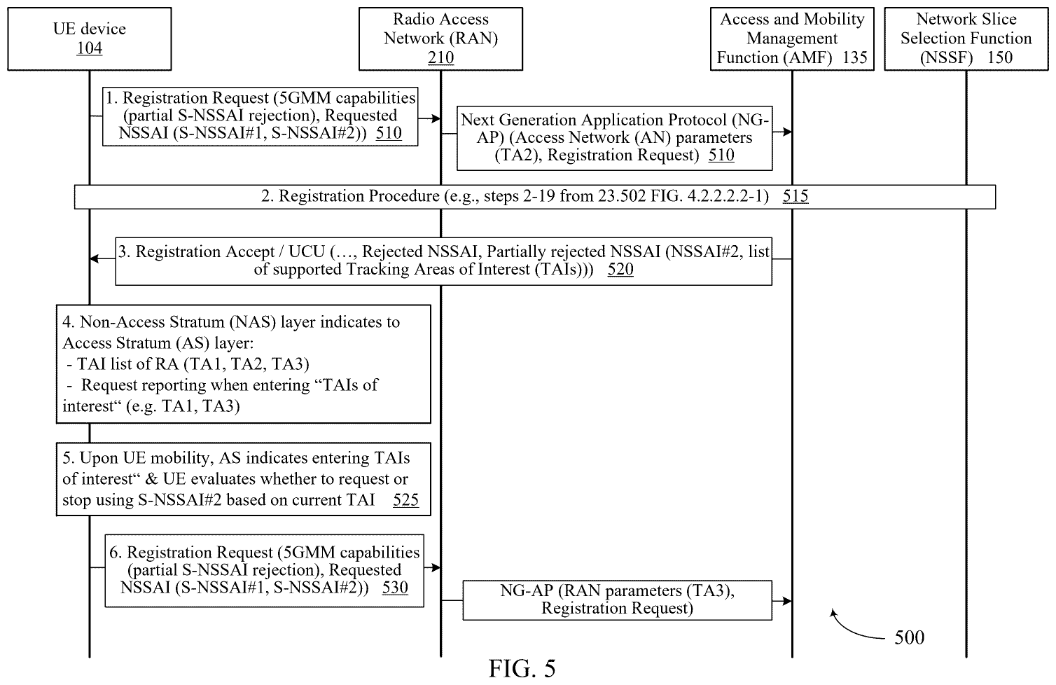

FIG. 5 depicts a signaling flow diagram 500 for registration procedure by a UE with partially rejected NSSAI. In signal flow diagram 500, messages are transmitted between UE and network components, including radio access network (RAN) 210 and 5GC components that support network slice allocations, namely AMF 135 and NSSF 150. Arrows indicate the directional flow of each transmission. The UE 104 initiates a registration procedure with the network by sending a NAS registration request message 510 to the network (e.g., to AMF 135). The message is encapsulated in an access stratum signaling message to the access network (e.g., RAN 210). The UE 104 includes in the NAS registration request message a core network capability indication that the UE supports partial S-NSSAI rejection. In one embodiment, the indication from the UE to the AMF may be transmitted in the 5GMM Capability IE (or UE 5GMM Core Network Capability). For example, the UE's 5GMM Core Network Capability may be enhanced to include a new parameter called “partial network slice rejection in the RA”. Alternatively, in one embodiment the indication from the UE 104 to the AMF 135 may be transmitted as a new parameter (or Informational Element) in the registration request message. The new parameter can be referred to as a “partial network slice rejection in the RA”.

According to one embodiment, the AMF stores the UE capability in the UE context (e.g., NAS context). According to one embodiment, the NSSF is involved in the creation of RA, allowed NSSAI, and (partially) rejected NSSAI, and the AMF forwards to the NSSF the indication that the UE supports partial S-NSSAI rejection (i.e., the core network capability indication that the UE supports partial S-NSSAI rejection). The AMF and/or NSSF takes the indication that the UE supports partial S-NSSAI rejection when creating the RA, allowed NSSAI, and/or rejected NSSAI to be assigned to the UE.

At step 2 of the signaling flow diagram 500, the network performs further steps (e.g., steps 2-19 form FIG. 4.2.2.2.2) for the registration procedure 515, with the exception that the steps for exchange between AMF and NSSF may be enhanced as described above.

At step 3 of the signaling flow diagram 500, the AMF (and/or together with NSSF) determines the UE's RA and the network slice configuration for the UE, which includes at least one of the allowed NSSAI and (partially) rejected NSSAI. Referring to the example of FIG. 3, the AMF determines that S-NSSAI #1 is included in the allowed NSSAI and the S-NSSAI #2 is included in the rejected NSSAI, since the S-NSSAI #2 is not supported in the current TA2. However, (optionally based on the indicated UE capability of partially rejected NSSAI as per step 1) the AMF determines to partially reject the S-NSSAI #2 in the TA2 where the S-NSSAI #2 is not supported, where the partial rejection of the S-NSSAI #2 is indicated by a specific reject cause of partial/local rejection valid in some TAs (or TAIs) of the RA.

The AMF sends to the UE a NAS registration accept message 520. The NAS registration accept message may contain a rejected NSSAI, including a partially rejected S-NSSAI (e.g., S-NSSAI #2) with a reject cause of partially rejected in the RA and an associated list of one or more TAIs where the partially rejected S-NSSAI (e.g., S-NSSAI #2) is supported. In an alternate embodiment, the AMF may instead include a list of one or more TAIs where the partially rejected S-NSSAI (e.g., S-NSSAI #2) is not supported. According to one alternate embodiment, the AMF includes the partially rejected NSSAI in other NAS messages sent, e.g., in the UE configuration update command message part of the UE configuration update procedure.

At step 4 of the signaling flow diagram 500, following reception of the NAS registration request message, the UE (and specifically the NAS layer) stores the received network slice configuration information (e.g., containing allowed NSSAI, rejected NSSAI and partially rejected NSSAI associated with a list of TAIs) in the NAS context. According to one aspect, this storing of the network slice configuration information only occurs when an update is received from the network or the UE enters Deregistered state. The UE stores the partially rejected NSSAI and the associated list of TAIs where the S-NSSAI is supported (or not supported) for each partially rejected S-NSSAI. The UE creates information to be configured in the UE AS layer, e.g., Idle state mobility and/or Connected state mobility. This information may contain a list of TAIs (e.g., TA1, TA2, TA3) corresponding to the RA where the UE is allowed to move without triggering the MRU procedure.

According to one aspect, the UE NAS layer creates a list of “TAIs of interest”, which includes the TAIs from the partially rejected S-NSSAIs. The UE AS layer indicates to the NAS layer i) the TAI of the cell and optionally the ii) cell ID. In such configuration, the UE AS would report only the TAIs (i.e., when the UE enters a cell of the TAI) included in the list “TAIs of interest”. Alternatively, the UE NAS layer can request the UE AS layer to always report the TAI when a cell of a new TAI is re-selected (in Idle mode) or during a handover procedure (in Connected state). In this embodiment, the AS layer reports a TAI change and/or the TAI itself.

At step 5 of the signaling flow diagram 500, when the UE becomes mobile (whether in Idle mode or in Connected mode) and when the new cell is part of a TAI of the list “TAIs of interest”, the UE AS indicates to the UE NAS layer that the UE is entering a TAI included in the list of “TAIs of interest” and provides the TAI itself.

At block 525, the UE evaluates whether to perform an MRU in order to request a registration to S-NSSAI #2. The trigger for evaluation may be a) due to the mobility in the TAI where the S-NSSAI #2 is supported, or b) due to an application requesting a connectivity to a PDU Session which includes the S-NSSAI #2 (e.g., this may happen at any time). The UE evaluates (i) whether the S-NSSAI #2 is rejected with a reject cause value partially rejected and (ii) whether the S-NSSAI #2 is supported in the TAI of the current location. In the example of FIG. 3, the UE 104 may determine that S-NSSAI #2 is supported and may request registration if the UE moves to TA1 or TA3 and there is an application on UE that wants to use the S-NSSAI #2.

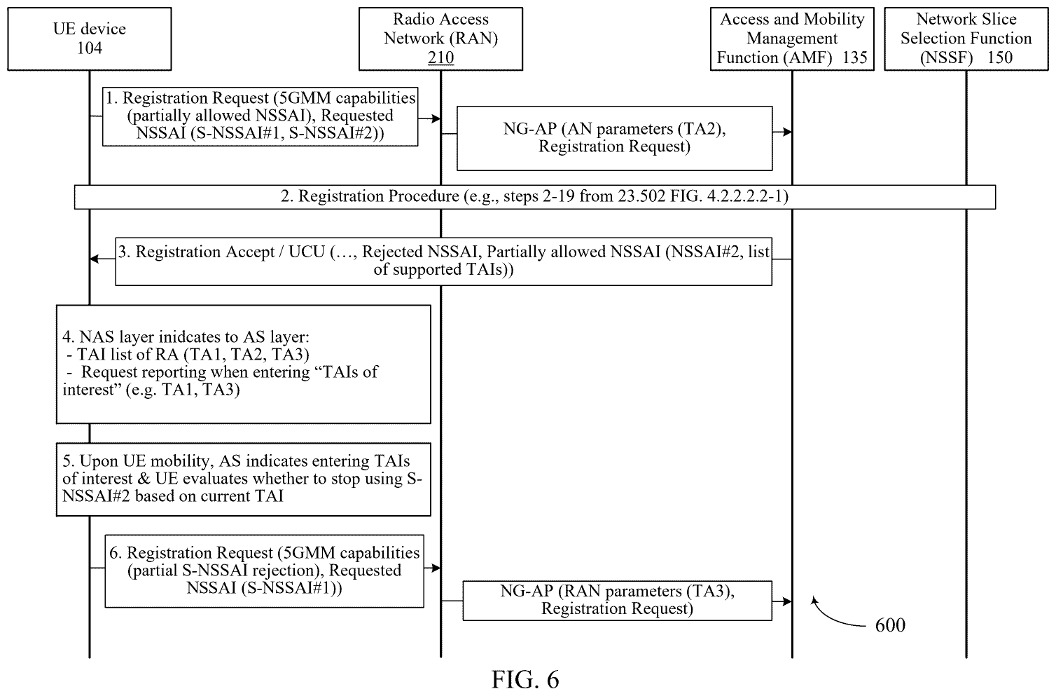

In addition, if the UE has registered with a previously partially rejected S-NSSAI, then this S-NSSAI may be denoted as partially allowed, and if furthermore the UE moves to a TAI of the RA where the partially allowed S-NSSAI is not supported, the UE may stop using the partially allowed S-NSSAI (e.g., S-NSSAI #2). Accordingly, the UE may (i) trigger an MRU procedure to deregister from the partially rejected S-NSSAI or the network (e.g., AMF), (ii) trigger a UE configuration update procedure to update the allowed NSSAI and the rejected NSSAI by including the partially rejected S-NSSAI in the partially rejected NSSAI, or (iii) stop using the PDU Session(s) associated with the S-NSSAI #2, as further described in FIG. 6. The UE or the network may, in addition, release the PDU Sessions to the partially rejected S-NSSAI (e.g., S-NSSAI #2) or modify the status of the PDU Sessions to suspended or inactive (e.g., suspended for user plane transmission).

At step 6 of the signaling flow diagram 500, in response to the UE determining in step 5 to request a registration to the S-NSSAI #2, the UE sends a registration request 530 with type ‘mobility registration’ and may include 5GMM Core network capabilities (e.g., partial S-NSSAI rejection) and Requested NSSAI (S-NSSAI #1, S-NSSAI #2). The UE includes the S-NSSAI #2 if the S-NSSAI #2 was rejected with cause value partially rejected in the RA. The AMF 135 (and/or together with NSSF 150) determines whether to accept or reject the S-NSSAI #1 or S-NSSAI #2, and the AMF/NSSF determine the new registration area for the UE. The AMF may send a registration accept message to the UE including the new RA, allowed NSSAI, partially allowed NSSAI, rejected NSSAI and/or partially rejected NSSAI.

According to one aspect, the benefit of the above-described solution is that the network is able to indicate to the UE that a rejected S-NSSAI may be available in another TA (e.g., TA1 or TA3) of the RA. This allows the UE to initiate a registration for a rejected S-NSSAI that was rejected in a first TA (e.g., TA2) of the RA but may be available in another TA (e.g., TA1 or TA3) of the RA, as illustrated with the example of FIG. 3.

In a second or alternate embodiment, a different parameter “partially allowed NSSAI” is sent to the UE to indicate the S-NSSAIs which are not supported in some TAs of the RA. With continued reference to FIG. 4, the UE may request the registration to S-NSSAI #1 and S-NSSAI #2 from TA2, which supports both network slices. However, the neighboring TAs do not support S-NSSAI #2. According to this second embodiment, the AMF sends to the UE a parameter called partially allowed NSSAI (or locally allowed NSSAI) which contains S-NSSAI #2 and the associated TAs where the S-NSSAI #2 is supported/allowed (e.g., TA2).

FIG. 6 depicts a signaling flow diagram 600 for completing a registration procedure with partially allowed NSSAI. Some of the steps of signal flow diagram 600 are similar to those of FIG. 5 and most of the details of those repeated steps are not presented again, for brevity. However, different from FIG. 5, in step 1 of FIG. 6, the UE 104 includes in the NAS registration request message an indication that the UE supports partial/local S-NSSAI allowance (or partially/locally allowed NSSAI). Transitioning to step 3, which overlaps in some respects to FIG. 5, the AMF determines to partially/locally allow the S-NSSAI #2 in TA2 where the S-NSSAI #2 is supported. The AMF 135 sends to the UE a NAS registration accept message (i.e., the mobility management message). The NAS registration accept message may contain either (1) a single allowed NSSAI including S-NSSAI #1 allowed in the whole RA and the partially/locally allowed S-NSSAI (e.g., S-NSSAI #2), with an additional information that S-NSSAI #2 is locally allowed and the list of TAs where it is supported or (2) one parameter of allowed NSSAI including S-NSSAI #1 allowed in the whole RA and one parameter of partially/locally allowed NSSAI. The partially/locally allowed NSSAI includes the S-NSSAIs (e.g., S-NSSAI #2) which are allowed in some TAs of the RA and includes an associated list of one or more TAIs where the partially allowed S-NSSAI (e.g., S-NSSAI #2) is supported. Alternatively, the list may provide one or more TAIs where the partially allowed S-NSSAI (e.g., S-NSSAI #2) is not allowed.

The partially allowed S-NSSAI means that the UE is only allowed to establish and activate (or use) a PDU Session associated with the partially allowed S-NSSAI in the TAs where the S-NSSAI is allowed/supported. In the TAs where the S-NSSAI is not allowed/supported, the UE should not initiate PDU Session establishment for the partially allowed S-NSSAI. Step 4 is similar to the previously described step 4 in FIG. 5.

In step 5 of signaling flow diagram 600, when UE mobility (e.g., device in Idle mode) is detected and when the new cell is part of a TAI within the list “TAIs of interest”, the UE AS indicates to the NAS layer that the UE is entering a TAI included in the list of “TAIs of interest” and the TAI itself. The UE AS can send this indication to the UE NAS in either Idle state or Connected state.

In step 6 of signaling flow diagram 600, after notification in step 5 that the UE enters a TA where the partially allowed S-NSSAI is not supported, the UE may initiate a NAS procedure to update the 5GC about the UE entering the TA where a partially allowed S-NSSAI is supported, or correspondingly is not supported. For example, the NAS procedure may be a NAS mobility management (MM) procedure (e.g., to send an indication to the AMF), or a NAS sessions management (SM) procedure (e.g., PDU Session modification procedure to the SMF). The UE evaluates whether there are established PDU Sessions to this S-NSSAI (e.g., S-NSSAI #2). According to one embodiment, the UE may initiate a procedure to suspend a PDU Session upon entering a TA where the partially allowed S-NSSAI is not supported. Alternatively, the UE may initiate a procedure to lift the suspension of a PDU Session upon entering a TA where the partially allowed S-NSSAI is not supported.

According to one embodiment, if a protocol data unit (PDU) Session has been established already in a TA where the partially allowed S-NSSAI is supported and the UE enters a TA where the PDU Session is not available, the UE may perform a signaling procedure to put the PDU Session in an inactive or suspended state. In one example, the UE may send to the SMF 140 a PDU Session modification request message including a new indication that the PDU Session should be suspended. In another example, the UE may inform the AMF 135 about the UE entering the TA where the partially allowed S-NSSAI is not supported. If there are established PDU Session(s) to this S-NSSAI, the AMF 135 may inform the one or more corresponding SMFs 140 serving the PDU Session(s) to suspend the PDU Session. As presented herein, the suspended/inactive state of PDU Session may refer to the stop or deferring of data transmission over the user plane of the PDU Sessions and/or the release of the corresponding radio bearer and N3 bearer of the PDU Session. However, the PDU Session context (e.g., for non-GBR QoS flows or bearers and associated traffic filters and signaling association between UE NAS session management instance and SMF) in the UE and in the SMF 235 or 250 (and correspondingly in the anchor UPF, e.g., 245, 255) may be stored. For example, when a downlink packet arrives at the anchor UPF, the anchor UPF may either buffer or discard the downlink packet, but the UPF will not transmit the downlink packet to the UE (and it is also proposed that the N3 tunnel towards the AN is released). Analogously, if the UE has an uplink packet to send, the UE would not transmit the uplink packet, but will indicate to the application that the connection is temporary not available. Alternatively, the UE may use another PDU Session associated with allowed S-NSSAIs (e.g., S-NSSAI #1). Such suspended/inactive state of PDU Session is similar to the deactivated user plane resources of a PDU Session.

According to anther embodiment, if a PDU Session has been established and consequentially suspended in a TA where the partially allowed S-NSSAI is not supported, and the UE enters a TA where the S-NSSAI is supported, the UE may perform a signaling procedure to lift the suspension of the PDU Session. The procedure to lift the suspension may be a PDU Session modification request message including a new indication that the PDU Session suspension is to be lifted. As another example, the procedure may be a NAS MM procedure to the AMF to inform the AMF about the UE entering the TA where the partially allowed S-NSSAI is supported.

According to another embodiment, if the UE is in a Connected state and the PDU Session(s) to the partially allowed S-NSSAI are in use, and the UE moves to a TA where the partially allowed S-NSSAI is not supported, the network (e.g., the source cell) will determine that the corresponding PDU Session(s) are not supported in the target cell. The source cell will correspondingly inform the UE that the radio bearers associated with the PDU Session(s) are not served in the target cell. The UE will take actions accordingly to release or suspend the PDU Sessions.

Among the benefits of this solution is that the UE is able to use a S-NSSAI locally or partially in a RA and there is no need to perform a registration procedure each time when the UE enters or leaves a tracking area where the S-NSSAI is supported. A further benefit is that the UE can establish a PDU Session to the partially allowed S-NSSAI from a TA where the S-NSSAI is supported, and upon entering a TA where the S-NSSAI is not supported, the PDU Session is suspended (i.e., suspended in the user plane to not transmit user data in the uplink or downlink).

It is appreciated that while presented as separate signaling diagrams, that the embodiments depicted in FIGS. 5 and 6 may be used together in a single solution. Thus, the UE can present a capability that indicates to the AMF that the UE supports both features, and the AMF may provide to the UE both parameters of partially rejected NSSAI and partially allowed NSSAI in the same NAS MM message (i.e., a registration accept message or UE configuration update command).

With reference again to the example of FIG. 3, using the embodiments of a partially rejected network slice, when the UE initiates the registration procedure from TA2, the AMF sends to the UE a partially/locally rejected S-NSSAI #2. When the UE moves to TA1, the UE can initiate MRU procedure to register to both S-NSSAI #1 and S-NSSAI #2. When applied to embodiments providing a partially allowed network slice, the AMF may send to the UE a partially/locally allowed S-NSSAI #2.

In each of the above described signaling diagrams, the descriptions present the list of TAIs provided to the UE (in steps 3) as inclusive of TAIs from the RA. However, according to one additional aspect, the access controller (e.g., AMF 135 and/or NSSF 150) may provide an additional one or more TAIs that are outside of the assigned RA to the UE. Being provided this additional list of TAIs is beneficial for the UE when performing cell selection outside the RA in order to select a cell from a TAI which supports the desired (or intentionally to be requested) S-NSSAI(s). With this functionality implemented, the UE may search for several cells from different TAIs and finally select a cell from a TAI which supports the to be requested S-NSSAI(s). As used herein, the “to be requested S-NSSAI(s)” refer to S-NSSAIs to which there are already established PDU Sessions in the old RA or S-NSSAI(s) to which the UE wants to establish a new PDU Session.

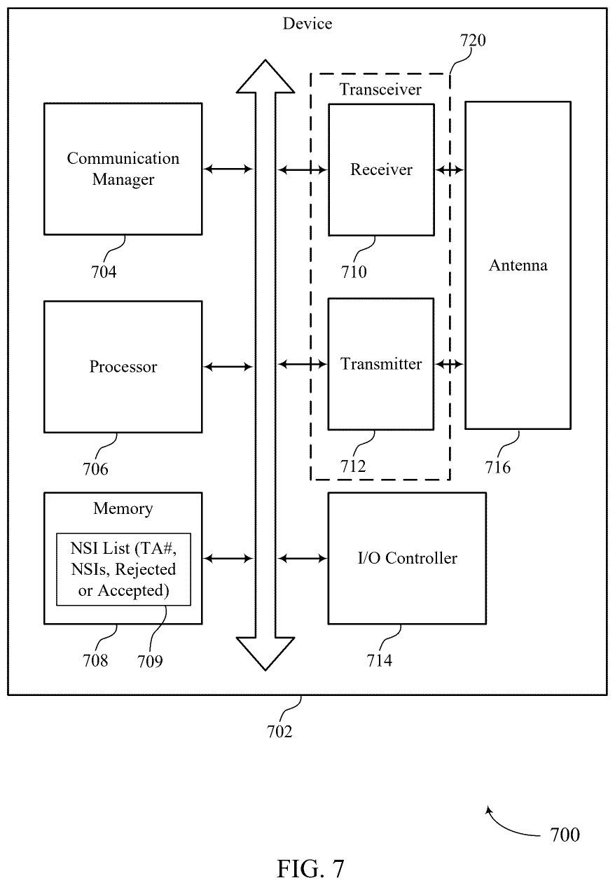

FIG. 7 illustrates an example of a block diagram 700 of a device 702 that supports partial network slice registration, in accordance with aspects of the present disclosure. The device 702 may be an example of a UE 104 as described herein. The device 702 may support wireless communication with one or more base stations 102, UEs 104, or any combination thereof. The device 702 may include components for bi-directional communications including components for transmitting and receiving communications, such as a communications manager 704, a processor 706, a memory 708 that stores TA list 709, a receiver 710, transmitter 712, and an I/O controller 714. These components may be in electronic communication or otherwise coupled (e.g., operatively, communicatively, functionally, electronically, electrically) via one or more interfaces (e.g., buses). The tracking area list 709 includes at least one of (i) a list of the TAs in which a partially allowed network slice is present, (ii) a list of the TAs in which a partially allowed network slice is not present, (iii) a list of the TAs in which a partially rejected network slice is present, or (iv) a list of the TAs in which a partially rejected network slice is not present. In one or more embodiment, the functionality of the transmitter and the receiver can be collectively referred to as being provided by a transceiver 720. In one or more embodiment, the transceiver 720 communicates with a mobile communication network that manages network slices within more than one tracking area, each tracking area supporting one or more network slices.

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally, or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication at a first device (e.g., the device 702) in accordance with examples as disclosed herein. The communications manager 704 may be configured as or otherwise enabled or provide means to: send a registration request message to the mobile communication network while the device is in a first tracking area, wherein the registration request message contains a core network capability indication that the device supports a partial registration of at least one network slice that is not available within all of the tracking areas in a registration area; receive, from the mobile communication network, a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area; and configure the device to use the local network slice of the partial network slice registration when the device is located in the tracking area supporting the local network slice.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

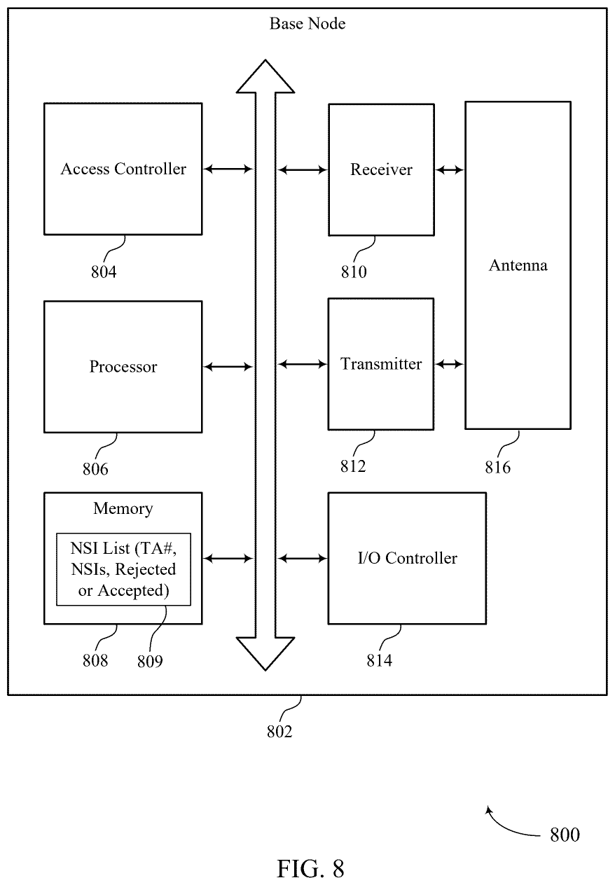

FIG. 8 illustrates an example of a block diagram 800 of a device 802 that supports assignment of RA and network slices to a UE with partially allowed or partially rejected network slices, in accordance with aspects of the present disclosure. The device 802 may be an example of a base station 102 as described herein. The device 802 may support wireless communication with one or more base stations 102, UEs 104, or any combination thereof. The device 802 may include components for bi-directional communications including components for transmitting and receiving communications, such as a communications manager 804, a processor 806, a memory 808 that stores network slice identifier (NSI) list 809, a receiver 810, transmitter 812, and an I/O controller 814. These components may be in electronic communication or otherwise coupled (e.g., operatively, communicatively, functionally, electronically, electrically) via one or more interfaces (e.g., buses).

The communications manager 804, the receiver 810, the transmitter 812, or various combinations thereof or various components thereof may be examples of means for performing various aspects of the present disclosure as described herein. For example, the communications manager 804, the receiver 810, the transmitter 812, or various combinations or components thereof may support a method for performing one or more of the functions described herein.

In some implementations, the communications manager 804, the receiver 810, the transmitter 812, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 806 and the memory 808 coupled with the processor 806 may be configured to perform one or more of the functions described herein (e.g., by executing, by the processor 806, instructions stored in the memory 808).

Additionally, or alternatively, in some implementations, the communications manager 804, the receiver 810, the transmitter 812, or various combinations or components thereof may be implemented in code (e.g., as communications management software or firmware) executed by the processor 806. If implemented in code executed by the processor 806, the functions of the communications manager 804, the receiver 810, the transmitter 812, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 804 may be configured to perform various operations (e.g., receiving, monitoring, transmitting) using or otherwise in cooperation with the receiver 810, the transmitter 812, or both. For example, the communications manager 804 may receive information from the receiver 810, send information to the transmitter 812, or be integrated in combination with the receiver 810, the transmitter 812, or both to receive information, transmit information, or perform various other operations as described herein. Although the communications manager 804 is illustrated as a separate component, in some implementations, one or more functions described with reference to the communications manager 804 may be supported by or performed by the processor 806, the memory 808, or any combination thereof. For example, the memory 808 may store code, which may include instructions executable by the processor 806 to cause the device 802 to perform various aspects of the present disclosure as described herein, or the processor 806 and the memory 808 may be otherwise configured to perform or support such operations.

For example, the communications manager 804 may support wireless communication at a first device (e.g., the device 802) in accordance with examples as disclosed herein. The communications manager 804 may be configured as or otherwise support a means for receiving by a transceiver that communicatively connects to a second device that registers with the network device for connectivity to a network, a registration request message comprising a core network capability indication that the second device supports partial registration with network slices. The communications manager 804 may be configured as or otherwise support a means for an access controller that is communicatively connected to the transceiver, in response to receipt of the core network capability indication configuring the network device to: identify a registration area including more than one tracking area and in which network slices are not supported within all of the more than one tracking area within the registration area; and transmit, to the second device, a mobility management message comprising: parameters for the registration area, a partial network slice registration identifying at least one local network slice that is not available in all tracking areas within the registration area, and an associated list of tracking areas in which the local network slice is one of allowed or rejected.

The processor 806 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 806 may be configured to operate a memory array using a memory controller. In some other implementations, a memory controller may be integrated into the processor 806. The processor 806 may be configured to execute computer-readable instructions stored in a memory (e.g., the memory 808) to cause the device 802 to perform various functions of the present disclosure.

The memory 808 may include random access memory (RAM) and read-only memory (ROM). The memory 808 may store computer-readable, computer-executable code including instructions that, when executed by the processor 806 cause the device 802 to perform various functions described herein. The code may be stored in a non-transitory computer-readable medium such as system memory or another type of memory. In some implementations, the code may not be directly executable by the processor 806 but may cause a computer (e.g., when compiled and executed) to perform functions described herein. In some implementations, the memory 808 may include, among other things, a basic I/O system (BIOS) which may control basic hardware or software operation such as the interaction with peripheral components or devices.

The I/O controller 814 may manage input and output signals for the device 802. The I/O controller 814 may also manage peripherals not integrated into the device 802. In some implementations, the I/O controller 814 may represent a physical connection or port to an external peripheral. In some implementations, the I/O controller 814 may utilize an operating system such as iOS®, ANDROID®, MS-DOS®, MS-WINDOWS®, OS/2®, UNIX®, LINUX®, or another known operating system. In some implementations, the I/O controller 814 may be implemented as part of a processor, such as the processor 806. In some implementations, a user may interact with the device 802 via the I/O controller 814 or via hardware components controlled by the I/O controller 814.

In some implementations, the device 802 may include a single antenna 816. However, in some other implementations, the device 802 may have more than one antenna 816, which may be capable of concurrently transmitting or receiving multiple wireless transmissions. The receiver 810 and the transmitter 812 may communicate bi-directionally, via the one or more antennas 816, wired, or wireless links as described herein. For example, the receiver 810 and the transmitter 812 may represent a wireless transceiver and may communicate bi-directionally with another wireless transceiver. The transceiver may also include a modem to modulate the packets, to provide the modulated packets to one or more antennas 816 for transmission, and to demodulate packets received from the one or more antennas 816.

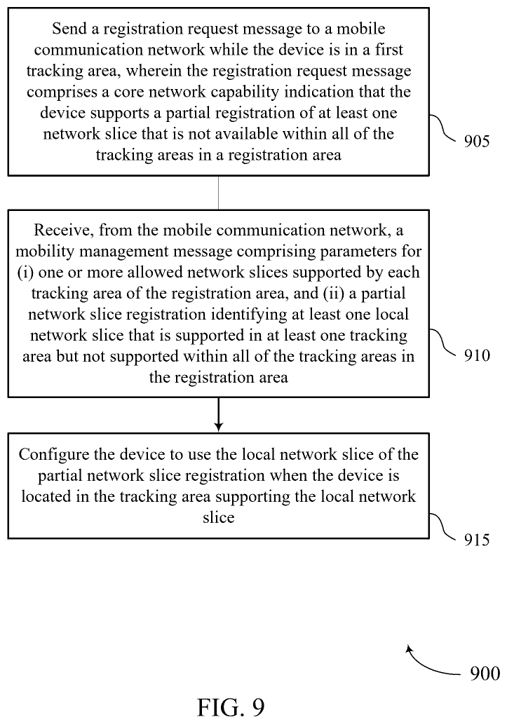

FIG. 9 illustrates a flowchart of a method 900 that supports a UE requesting partial registration to network slices in accordance with aspects of the present disclosure. The operations of the method 9 may be implemented by a device or its components as described herein. For example, the operations of the method 900 may be performed by a device such as a UE 104 as described with reference to FIGS. 1 through 6 or device 702 (FIG. 7). In some implementations, the UE 104, may execute a set of instructions to control the function elements of the device to perform the described functions. Additionally, or alternatively, the device may perform aspects of the described functions using special-purpose hardware.

At 905, the method may include sending a registration request message to a mobile communication network while the device is in a first tracking area, wherein the registration request message comprises a core network capability indication that the device supports a partial registration of at least one network slice that is not available within all of the tracking areas in a registration area. The operations of 905 may be performed in accordance with examples as described herein. In some implementations, aspects of the operations of 905 may be performed by a device as described with reference to FIG. 1.

At 910, the method may include receiving, from the mobile communication network, a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area. The operations of 910 may be performed in accordance with examples as described herein. In some implementations, aspects of the operations of 910 may be performed by a device as described with reference to FIG. 1.

At 915, the method may include configuring the device to use the local network slice of the partial network slice registration when the device is located in the tracking area supporting the local network slice. The operations of 915 may be performed in accordance with examples as described herein. In some implementations, aspects of the operations of 915 may be performed by a device as described with reference to FIG. 1.

In some implementations of the method and apparatuses described herein, the capability indication indicates that the device supports partially allowed network slices. The partial network slice registration includes a partially allowed network slice that is available in the first tracking area and an associated list of tracking areas in which the partially allowed network slice is allowed. Some implementations of the method and apparatuses described herein may further include, in response to determining movement to a second tracking area in which the partially allowed network slice is unavailable, reconfiguring the device to stop using the partially allowed network slice while in the second tracking area.

Some implementations of the method and apparatuses described herein may further include reconfiguring the device in the second tracking area comprises at least one of: (i) initiating a procedure to suspend a data sessions associated with the partially allowed network slice, wherein the procedure to suspend the data sessions is a PDU session modification procedure including an indication for session suspension; and (ii) releasing a data session associated with the partially allowed network slice.

Some implementations of the method and apparatuses described herein may further include receiving, within the mobility management message, the partial network slice registration, which comprises: (i) at least one of a partially rejected network slice and a partially allowed network slice; (ii) a reject cause for each partially rejected network slice; and (iii) a tracking area list of one or more tracking areas in which an identified network slice is partially rejected or partially allowed. The method includes storing the received network configuration information in response to receiving an update from the network or the device entering a reregistered state.

Some implementations of the method and apparatuses described herein may further include, in response to the partial network slice registration comprising a partially rejected slice, the method includes storing the partially rejected slice with the reject cause, along with the tracking area list of one of supported or not supported tracking areas for the partially rejected slice. In response to the partial network slice registration comprising a partially allowed slice, the method includes storing the partially allowed slice, along with the tracking area list of one of supported or not supported tracking areas for the partially allowed slice.

Some implementations of the method and apparatuses described herein may further include monitoring the tracking area list for entry by the device into a new tracking area represented on the tracking area list. In response to the device entering the new tracking area, the method includes: triggering reconfiguration of the device to operate within the new tracking area; and updating the tracking area list during one of a reselection or a handover procedure.

Some implementations of the method and apparatuses described herein may further include receiving, within the mobility management message, parameters of at least one additional tracking area outside of the registration area of the device that is associated with a network slice. The method includes storing the parameters of the at least one additional tracking area. The method includes selecting the at least one additional tracking area during a subsequent cell selection outside of the registration area, in order to register the device with the associated network slice.

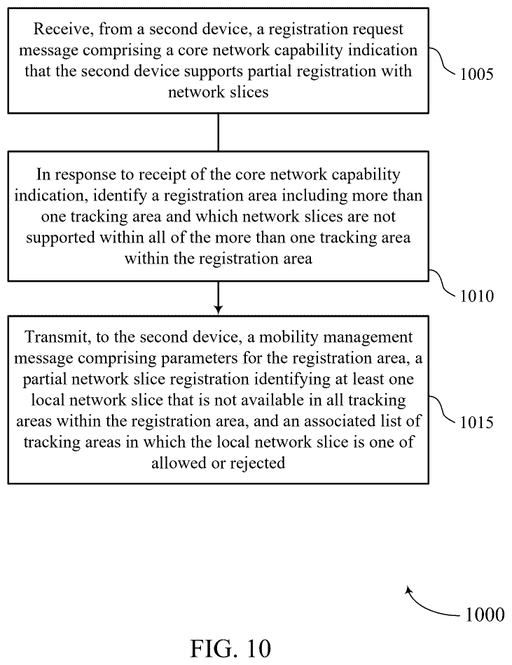

FIG. 10 illustrates a flowchart of a method 1000 that supports access controller of a network assigning, to a UE, an RA with partially rejected or partially allowed network slices, in accordance with aspects of the present disclosure. The operations of the method 1000 may be implemented by a device or its components as described herein. For example, the operations of the method 1000 may be performed by a base station 102 and/or mobile core network 106 as described with reference to FIGS. 1 through 6 or network device 802. In some implementations, the device may execute a set of instructions to control the function elements of the device to perform the described functions. Additionally, or alternatively, the device may perform aspects of the described functions using special-purpose hardware.

At 1005, the method may include receiving, from a second device, a registration request message comprising a core network capability indication that the second device supports partial registration with network slices. The operations of 1005 may be performed in accordance with examples as described herein. In some implementations, aspects of the operations of 1005 may be performed by a device as described with reference to FIG. 1 or 2.

At 1010, the method may include, in response to receipt of the core network capability indication, identifying a registration area including more than one tracking area and which network slices are not supported within all of the more than one tracking area within the registration area. The operations of 1010 may be performed in accordance with examples as described herein. In some implementations, aspects of the operations of 1010 may be performed by a device as described with reference to FIG. 1 or 2.

At 1015, the method may include transmitting, to the second device, a mobility management message comprising parameters for the registration area, a partial network slice registration identifying at least one local network slice that is not available in all tracking areas within the registration area, and an associated list of tracking areas in which the local network slice is one of allowed or rejected. The operations of 1015 may be performed in accordance with examples as described herein. In some implementations, aspects of the operations of 1015 may be performed by a device as described with reference to FIG. 1 or 2. It should be noted that the methods described herein describe possible implementations, and that the operations and the steps may be rearranged or otherwise modified and that other implementations are possible. Further, aspects from two or more of the methods may be combined.

In one or more embodiments, the method 1000 includes receiving the core network capability indication as one of (a) a parameter within a core network capability message or (b) a new parameter. The access controller generates the mobility management message to include at least one allowed network slice and to include the partial network slice registration within one of (i) in a single parameter together with the at least one allowed network slice or (ii) a separate parameter from the at least one allowed network slice.

In one or more embodiments, the method 1000 includes generating the mobility management message, by incorporating, within the mobility management message, the partial network slice registration, which comprises: (i) at least one of a partially rejected network slice and a partially allowed network slice; (ii) a reject cause for each partially rejected network slice; and (iii) a tracking area list of one or more tracking areas in which an identified network slice is partially rejected or partially allowed.

In one or more embodiments, the method 1000 includes generating the mobility management message by: (i) partially rejecting a specific network slice in a specific tracking area when the specific network slice is not supported within the specific tracking area; and (ii) incorporating identifying details of the specific network slice and the specific tracking area within the mobility management message.

In one or more embodiments, the method 1000 includes identifying at least one additional tracking area that supports a requested slice, the at least one additional tracking area located outside of the registration area. The method 1000 includes transmitting, with the mobility management message, parameters of at least one additional tracking area to enable the second device to register with the at least one additional tracking area during a subsequent search for selecting a cell with the requested slice outside the registration area.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, the user equipment comprising:
a memory;
a transceiver that communicates with a mobile communication network that manages network slices within more than one tracking area, each tracking area supporting one or more network slices; and
a processor communicatively coupled to the memory and the transceiver and which is configured to cause the UE to:
send a registration request message to the mobile communication network, wherein the registration request message contains a core network capability indication that the device supports a partial registration of at least one network slice that is not available within all of the tracking areas in a registration area;
receive, from the mobile communication network, a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area; and
configure the device to use the local network slice of the partial network slice registration when the device is located in the tracking area supporting the local network slice.

2. The UE of claim 1, wherein:
the received mobility management message is one of a registration accept message or a device configuration update command; and
the at least one local network slice is a partially allowed or partially rejected network slice.

3. The device UE of claim 1, wherein:
the capability indication indicates that the device supports partial rejection of network slices;
the partial network slice registration comprises a partially rejected network slice that is unavailable in the first tracking area and an associated list of tracking areas in which the partially rejected network slice is one of available or unavailable; and
the processor is configured to cause the UE to:
in response to one of (i) detecting device movement to a tracking area in which the partially rejected network slice becomes available and (ii) an application requesting a connectivity to the partially rejected network slice, send to the mobile communication network a registration request for the partially rejected network slice.

4. The UE of claim 1, wherein:
the capability indication indicates that the device supports partially allowed network slices;
the partial network slice registration comprises a partially allowed network slice that is available in the first tracking area and an associated list of tracking areas in which the partially allowed network slice is available; and
the processor is further configured to cause the UE to, in response to determining movement to a second tracking area in which the partially allowed network slice is unavailable, reconfigures the device to stop using the partially allowed network slice while in the second tracking area.

5. The UE of claim 4, wherein to reconfigure the device in the second tracking area, the processor is configured to cause the UE to perform one of:
initiate a procedure to suspend a data session associated with the partially allowed network slice, wherein the procedure to suspend the data sessions is a PDU session modification procedure including an indication for session suspension; and
release the data session associated with the partially allowed network slice.

6. The UE of claim 1, wherein the processor is configured to cause the UE to:
receive, within the mobility management message, the partial network slice registration which comprises:
at least one of a partially rejected network slice and a partially allowed network slice;
a reject cause for each partially rejected network slice; and
a tracking area list of one or more tracking areas in which an identified network slice is partially rejected or partially allowed; and
stores received network configuration information in response to receiving an update from the network or the device entering a reregistered state.

7. The UE of claim 6, wherein:
in response to the partial network slice registration comprising a partially rejected slice, the processor is configured to cause the UE to store the partially rejected slice with the reject cause, along with the tracking area list of one of supported or not supported tracking areas for the partially rejected slice; and
in response to the partial network slice registration comprising a partially allowed slice, the processor is configured to cause the UE to store the partially allowed slice, along with the tracking area list of one of supported or not supported tracking areas for the partially allowed slice.

8. The UE of claim 6, wherein the processor is configured to cause the UE to:
monitor the tracking area list for entry by the device into a new tracking area represented on the tracking area list; and
in response to the device entering the new tracking area:
trigger reconfiguration of the device to operate within the new tracking area; and
update the tracking area list during one of a reselection or a handover procedure.

9. The UE of claim 1, wherein the processor is configured to cause the UE to:
receive, within the mobility management message, parameters of at least one additional tracking area outside of the registration area of the device that is associated with a network slice;
store the parameters of the at least one additional tracking area; and
select the at least one additional tracking area during a subsequent cell selection outside of the registration area in order to register the device with the associated network slice.

10. A base station for wireless communication, the base station comprising:
a transceiver that communicatively connects to a user equipment (UE) that registers with the network device for connectivity to a network, the transceiver receiving from the user equipment a registration request message comprising a core network capability indication that the user equipment supports partial registration with network slices; and
an access controller that is communicatively connected to the transceiver and which, in response to receipt of the core network capability indication configures the base station to:
identify a registration area including more than one tracking area and in which network slices are not supported within all of the more than one tracking area within the registration area; and
transmit, to the equipment, a mobility management message comprising: parameters for the registration area, a partial network slice registration identifying at least one local network slice that is not available in all tracking areas within the registration area, and an associated list of tracking areas in which the local network slice is one of allowed or rejected.

11. The base station of claim 10, wherein:
the core network capability indication is received as one of (a) a parameter within a core network capability message or (b) a new parameter; and
the access controller is configured to cause the base station to generate the mobility management message to include at least one allowed network slice and to include the partial network slice registration within one of (i) in a single parameter together with the at least one allowed network slice or (ii) a separate parameter from the at least one allowed network slice.

12. The base station of claim 10, wherein:
the capability indication comprises a parameter indicating that the UE supports partial rejection of network slices; and
the partial network slice registration comprises a partially rejected network slice that is unavailable in a first tracking area but available in a second tracking area and a list of associated tracking areas in which the partially rejected network slices are one of rejected or allowed.

13. The base station of claim 10, wherein:
the capability indication comprises a parameter indicating that the device supports partially allowed network slice; and
the partial network slice registration comprises a partially allowed network slice that is available in a first tracking area but unavailable in other tracking areas and an associated list of tracking areas in which the partially allowed network slices are one of allowed or rejected.

14. The base station of claim 10, wherein to generate the mobility management message, the access controller incorporates, within the mobility management message, information that comprises:
at least one of a partially rejected network slice and a partially allowed network slice;
a reject cause for each partially rejected network slice; and
a tracking area list of one or more tracking areas in which an identified network slice is partially rejected or partially allowed.

15. The base station of claim 10, wherein to generate the mobility management message, the access controller causes the base station to:
partially reject a specific slice in a specific tracking area when the specific slice is not supported within the specific tracking area; and
incorporate identifying details of the specific slice and the specific tracking area within the mobility management message.

16. The base station of claim 10, wherein the access controller causes the base station to:
identify at least one additional tracking area that supports an associated network slice, the at least one additional tracking area located outside of the registration area; and
transmit, with the mobility management message, parameters of the at least one additional tracking area to enable the UE to register with the associated network slice within the at least one additional tracking area during a subsequent cell selection outside the registration area.

17. The base station of claim 10, wherein the access controller comprises one or both of an access and mobility management function (AMF) and a network slice selection function (NSSF), wherein the AMF stores the capability within a device context and forwards the core network capability indication to the NSSF to trigger the NSSF to generate the registration area and partial network slice registration.

18. A method for wireless communication by a user equipment (UE), the method comprising:
sending a registration request message to a mobile communication network, wherein the registration request message comprises a core network capability indication that the user equipment supports a partial registration of at least one network slice that is not available within all of the tracking areas in a registration area;
receiving, from the mobile communication network, a mobility management message comprising parameters for (i) one or more allowed network slices supported by each tracking area of the registration area, and (ii) a partial network slice registration identifying at least one local network slice that is supported in at least one tracking area but not supported within all of the tracking areas in the registration area; and
configuring the user equipment to use the local network slice of the partial network slice registration when the user equipment is located in the tracking area supporting the local network slice.

19. The method of claim 18, wherein:
the capability indication indicates that the user equipment supports partial rejection of network slices;
the partial network slice registration comprises a partially rejected network slice that is unavailable in the first tracking area and an associated list of tracking areas in which the partially rejected network slice is one of available or unavailable; and
the method comprises, in response to one of (i) detecting device movement to a tracking area in which the partially rejected network slice becomes available and (ii) an application requesting a connectivity to the partially rejected network slice, sending to the mobile communication network a registration request for the partially rejected network slice.

20. The method of claim 18, wherein:
the received mobility management message is one of a registration accept message or a device configuration update command;
the at least one local network slice is a partially allowed or partially rejected network slice; and
the method further comprises:
receiving, within the mobility management message, the partial network slice registration, which comprises:
at least one of a partially rejected network slice and a partially allowed network slice;
a reject cause for each partially rejected network slice; and
a tracking area list of one or more tracking areas in which an identified network slice is partially rejected or partially allowed;
storing received network configuration information in response to receiving an update from the mobile communication network or the user equipment entering a reregistered state;
monitoring the tracking area list for entry by the user equipment into a new tracking area represented on the tracking area list; and
in response to the user equipment entering the new tracking area:
triggering reconfiguration of the user equipment to operate within the new tracking area; and
updating the tracking area list during one of a reselection or a handover procedure.
